(19) United States
(12) Patent Application Publication
(10) Pub. No.: US 2007/0031800 A1
(43) Pub. Date: Feb. 8, 2007

(54) Method of matching people

(75) Inventor: Elena Vladimirovna Solomon, Robina Queensland (AU)

Correspondence Address: HOUSTON ELISEEVA, 4 MILITIA DRIVE, SUITE 4, LEXINGTON, MA, 02421, US

(73) Assignee: Soulmades PTY Ltd., Robina Town Centre, Queensland (AU)

(21) Appl. No.: 10/569,912

(22) PCT Filed: Sep. 1, 2004
(86) PCT No.: PCT/AU04/01183

§ 371 Date: Feb. 28, 2006

(30) Foreign Application Priority Data
Sep. 1, 2003 (AU) 2003904716

(51) Int. Cl. G09B 3/00; G09B 7/00

(52) U.S. Cl. 434/322; 434/236; 434/362

(57) ABSTRACT

An improved method of matching people is disclosed. The method includes the steps of providing a first set of questions to a first person. The person provides answers to the first set of questions and these answers are analysed. The method further includes the step of providing one or more further sets of questions to the first person wherein the content of each further set of questions is determined by the persons answers to one or more preceding set(s) of questions. A character profile of the person is developed in response to the persons answer to the firs set of questions and the one or more further sets of questions. The person is then matched to one or more other persons based on compatible character profiles amongst other indicators.

### FIELD OF THE INVENTION

The invention relates to a method of matching people. In particular, although not exclusively, the invention relates to an effective method of finding suitable partners for people using psychological matching criteria.

### BACKGROUND TO THE INVENTION

The use of web based dating services has become increasingly popular among singles looking for life partners. Until recently, dating and relationship web sites have been viewed as being used by people who are socially inept and cannot find a partner or start a relationship any other way. Internet dating sites are now viewed as an acceptable and convenient means of finding a partner and their use has now moved into mainstream society.

There are a multitude of web sites that offer to match prospective partners together. Match.com (found at www.match.com) is one such web site that helps singles find partners. This site matches prospective partners by having people complete a questionnaire that asks them to describe themselves, their interests and the qualities preferred in a partner among other questions. Their answers to these questions are compiled into a profile that is published on the Match web-site. Optionally, the person can elect to include a personal photo that is published with their profile.

Matching of people with perspective partners is achieved by people viewing the published profiles on the web site, finding people that they feel they would be compatible with and then contacting these people. This method of matching people is deficient because people will tend to misrepresent themselves when completing the questionnaire in an effort to make them more attractive to other people.

Additionally, the method of matching people is done solely by people reading profiles and determining whether they believe that they could be compatible with this person, based on this persons profile. Hence, this method is not effective at producing compatible matches because people are choosing potential partners based on inaccurate information provided and also based on the material characteristics of their potential partner. Thus, in other words, compatibility between people's characters is never fully addressed.

The Cybersuitors (found at www.cybersuitors.com) Internet dating service attempts to add compatibility criteria to the matching process. The proprietors of this site have developed a Compatibility Quotient Test of 25 questions, each question having five possible answers. People are matched based on the similarity between the answers of each person to the questions. The questions are designed by psychologists and are based on the main causes of discontentment and breakdown in relationships.

While the method of matching people offered by Cybersuitors is more effective than the previously mentioned Internet dating sites, it is still deficient. There is still the capacity for people to lie and misrepresent their character when answering their questions thus rendering the method ineffective. Furthermore, it is questionable whether a thorough compatibility assessment can be conducted for a person based on the results of 25 questions only.

U.S. Pat. No. 6,735,568 discloses a method and system for identifying people who are likely to have a successful relationship. The method includes approximating the satisfaction that a user of the matching service has in the relationships that the user forms with others, and identifying candidates for a relationship with the user based on approximated satisfaction. This satisfaction is approximated by providing users with which include inquiries into matters that are relevant to formation of relationships with other people. People are matched based on this approximated satisfaction calculation.

Similar to the previous methods, it is questionable whether a through compatibility assessment of two people can be undertaken by offering generic questions to a person.

For these reasons, it is desirable to provide for an improved method of matching people.

### OBJECT OF THE INVENTION

An object of the invention is to overcome or at least alleviate one or more of the above problems and/or provide the consumer with a useful or commercial choice.

### DISCLOSURE OF THE INVENTION

In one form, although it need not be the only or indeed the broadest form, the invention resides in a method of matching people including the steps of:
a. providing a first set of questions to a first person;
b. analyzing a set of answers provided by said first person to said first set of questions;
c. one or more iterations of:
   i. providing a further set of questions to said first person, wherein the content of said further set of questions being determined by a set of answers provided by said first person to at least one previous set of questions; and
   ii. analyzing said set of answers provided by said first person to said further set of questions;
d. developing a character profile of said first person based on said analyses of said answers to said first set of questions in step (b) and said analyses of said answers to said further set(s) of questions in step (c(ii)); and
e. determining a compatibility of said first person with at least one other person based on said character profile of said first person and a character profile of each said other person.

Further features of the present invention will become apparent from the following detailed description.

### BRIEF DESCRIPTION OF THE DRAWINGS

In order that the invention may be more fully understood and put into practical effect, reference will now be made to the accompanying drawings in which:

FIG. 1 shows an embodiment of a system upon which a method of matching people according to an aspect of the present invention may be implemented;

FIG. 2 shows a method of matching people according to one aspect of the present invention;

FIG. 3 shows the method of FIG. 2 with the step of determining a character profile of a person shown in more detail; and

FIG. 4 shows the method of FIG. 2 with the step of matching compatible people shown in more detail.

### DETAILED DESCRIPTION OF THE INVENTION

The method of matching people according to the present invention involves developing an in-depth psychological profile of a person that is used to identify one or more compatible partners for that person. The method is described in detail below.

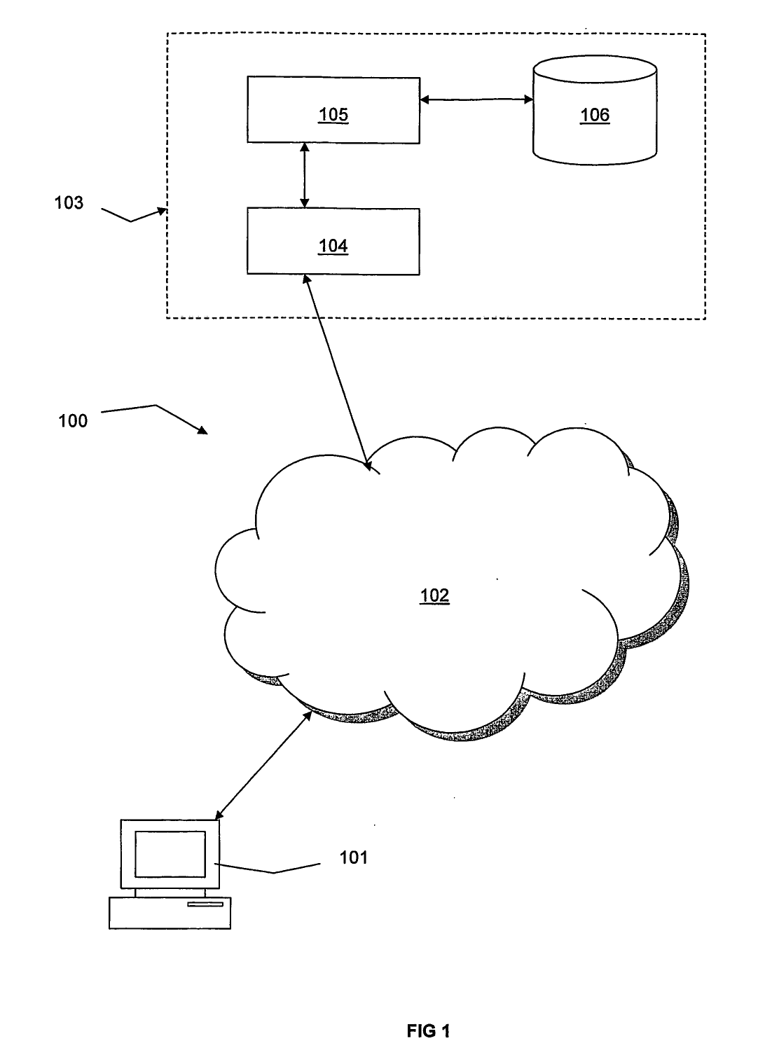

FIG. 1 shows a system 100 upon which the method of the present invention may be implemented. System 100 comprises a computing device 101 that is in operative communication with a matching service 103 via a network 102. Preferably, there are a plurality of computing devices 101 in operative communication with matching service 103 via network 102. Network 102 is preferably the Internet but it will be appreciated by a skilled person that network 102 may be any form of network such as a local area network (LAN) or a wireless network.

Matching service 103 is preferably an Internet site. Optionally, matching service 103 may be a server on a local network. Matching service 103 comprises a front-end module 104 that is in communication with an application software module 105. Application software module 105 is in communication with a storage module 106.

Front-end module 104 is a software module that is used to generate Internet web pages. These web pages are communicated to computing device 101 via network 102 and any return data generated by computing device 101 from activity on these web pages is received by front-end module 104.

All data received by front-end module 104 is communicated to application software module 105 for processing. The function of application software module 105 will be described in more detail below. Storage module 106 is preferably a database but may be any logical or physical component that allows data to be stored to and retrieved from. The function of system 100 will be described in more detail below.

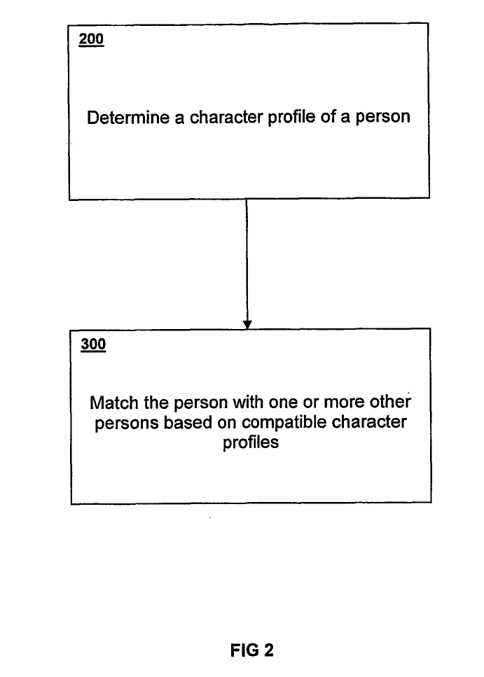

FIG. 2 shows a method of matching people according to one aspect of the present invention. The method of the present invention includes the steps of determining a character profile of a person (step 200) and matching a first person with one or more other persons based on the character profile of the first person and the one or more other persons (step 300).

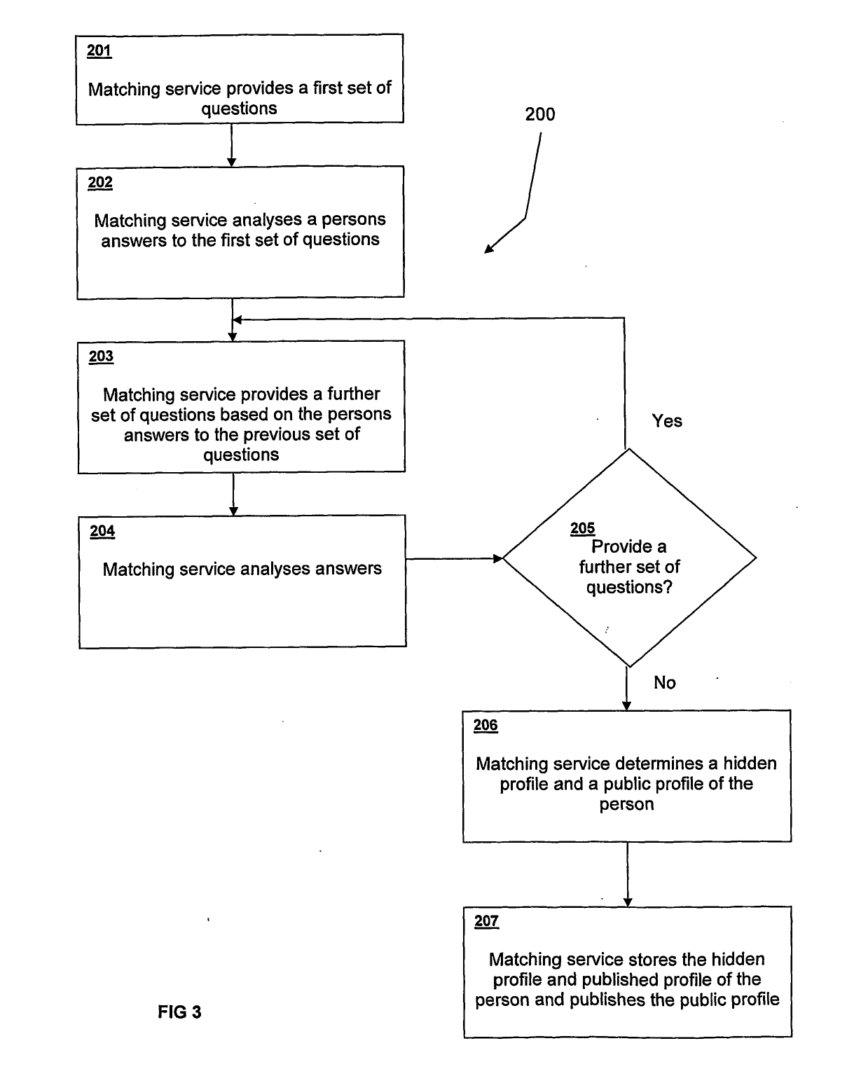

FIG. 3 shows the step of determining a character profile of a person (step 200) in more detail. A person is given a first set of questions (step 201) that are designed to probe the character of the person, their aspirations, their interests and their preference in a potential partner. Preferably, the set of questions communicated from matching service 103 to computing device 101 are multiple choice questions whereby the person is required to select an answer from a plurality of alternatives for each question. Optionally, each question may be in the form of true/false or yes/no type questions.

The first set of questions are communicated to computing device 101 from matching service 103 by means of network 102 in the form of an Internet web page. The person then interacts with computing device 101 to complete this first set of questions.

After the person has completed the first set of questions the answers are communicated to matching service 103 for analysis (step 202). In system 100, shown in FIG. 1, this would involve the answers being encrypted and sent over the Internet to the matching service 103 from computing device 101. Any form of known encryption technique may be used such as using Secure Socket Layers (SSL) technology or secure HTTP (HTTPS). The analysis is conducted by proprietary software operating within the application software module 105. This will be discussed in more detail below.

After the first set of questions have been analyzed by the matching service 103, a further set of questions is communicated from matching service 103 to computing device 101 for the person to complete (step 203). This further set of questions is customized by the application software module 105 based on the answers provided by the person to the first set of questions. The questions are aimed at further identifying characteristics and traits of the person as well as expanding upon their interests, hobbies and ambitions that were identified by matching service 103 in step 202.

After the person has completed this further set of questions the answers are communicated to the matching service 103 by means of network 102 and undergoes further analysis (step 204) as before.

The matching service 103 then determines whether it is necessary to provide the person with further sets of questions in order to accurately develop the character profile of that person (step 205). This determination step will be discussed in more detail below.

If the matching service 103 determines that more questions are necessary, steps 203 and 204 are repeated wherein a person is offered a set of questions that are based on the analysis the matching service has done on the answers the person has provided to the previous set of questions. As each set of questions are customized and are designed to further unlock aspects of a persons character, a more accurate character profile can be developed for that person by the matching service 103.

The feature of offering a number of dynamic, customizable question sets to a person is a distinct advantage of the method of the present invention. Prior art methods all offer a generic set of questions to determine a persons personality, interests, aspirations and the like. By offering a series of question sets wherein the content of each subsequent set is based on a persons answers to a previous question set, as in the method for the present invention, a more accurate and more detailed character profile can be developed.

In an optional embodiment, the method of the present invention provides questions in order to construct an honesty and consistency scale to determine how honestly and consistently a person is answering the questions provided by matching service 103.

For example, if a person is answering questions honestly then the responses to further set(s) of questions should be consistent with answers provided by the person to previous set(s) of questions. If answers are not consistent then it indicates that the person is not being honest and/or consistent whilst answering the questions. Importantly, a person is not able to determine which questions are used to construct the honesty and consistency scale as these questions appear to be aimed at determining their character profile hence the person cannot provide artificial results.

This highlights one advantage that the method of matching people of the present advantage has over current matching methods. The present invention is able to determine if people are providing honest and consistent answers to the questions provided by matching service 103. When a person is answering in a dishonest manner matching service 103 can detect this and deal with his appropriately. This will be discussed in more detail below.

One method employed by application software module 105 to generate further question sets is to have a number of predetermined sets of questions. For example, consider the case where a person has provided answers to a first set of questions and matching service 103 has determined that this person is an extrovert who has a positive outlook. In this case, matching service 103 may provide the person with a further question set, for example, which has questions tailored to further unlocking other characteristics of this person who is an extrovert with a positive outlook.

A simple example of the method of the present invention is given below. The questions provided in this example are aimed at determining whether a person is introverted or extroverted and the extent of this characteristic. The format of the example has the question, followed by a list of selections for the person and finally the scale of the options (from introverted to extroverted or vice versa). Obviously, the scale shown in the brackets would not appear on the question when a person is taking the test. It will be appreciated that this is an example only and the content of the questions is not limited to that provided below.

First Set of Questions

1. How easily do you make new friends? Options for answers are (only one choice allowed):
   a. Very easily, I make new friends wherever I go;
   b. Easily, I make new friends often;
   c. From time to time, I do make friends with some new people when I really like them;
   d. Seldom, I prefer to put an effort in maintaining existing friendships rather than seeking new ones;
   e. Nearly never, I doubt if I can find better friends than I already have.
(With (a) being a person who is strongly extroverted, (e) being a person who is strongly introverted and the remaining options being degrees of introverted/extroverted.)
2. If you need to start a conversation with a stranger, how far does it get? Options for answers are (only one choice allowed):
   a. Exchange a few meaningless phrases, that's all;
   b. Exchange opinions about some particular subject that is connected to why we are here;
   c. Find out about each other's backgrounds;
   d. Find out about each other's backgrounds and mutual interests;
   e. Have a deep conversation on a subject that is interesting to one or both of us;
   f. I never talk to strangers.
   (With (a) being a person who is strongly introverted, (f) being a person who is strongly extroverted and the remaining options being degrees of introverted/extroverted.)
3. How often does it happen that you say something without thinking that you regret later? Options for answers are (only one choice allowed):
   a. All the time;
   b. Quite often;
   c. Sometimes;
   d. Seldom;
   e. Never.
   (With (a) being a person who is strongly extroverted, (e) being a person who is strongly introverted and the remaining options being degrees of introverted/extroverted.)
4. How often does it happen that you are so involved in what you are doing that you do not hear other people asking you about something? Options for answers are (only one choice allowed):
   a. All the time;
   b. Quite often;
   c. Sometimes;
   d. Seldom;
   e. Never.
   (With (a) being a person who is strongly introverted, (e) being a person who is strongly extroverted and the remaining options being degrees of introverted/extroverted.)
5. If I had to spend half a year alone on a deserted island, I would feel like: Options for answers are (only one choice allowed):
   a. I would be mad in a couple of weeks;
   b. I would miss people in general;
   c. I would miss my family and friends;
   d. I would miss some people but enjoy the solitude;
   e. I would never want to leave.
   (With (a) being a person who is strongly extroverted, (e) being a person who is strongly introverted and the remaining options being degrees of introverted/extroverted.)
6. The social setting I would enjoy the most: Options for answers are (only one choice allowed):
   a. a large party with many new people to meet;
   b. a large family gathering;
   c. a party at friends' place with some new people to meet;
   d. a party at my home;
   e. the company of my close family and/or friends;
   f. the company of somebody special;
   g. the company of my favorite TV show;
   h. the company of a good book.
   (With (a) being a person who is strongly extroverted, (h) being a person who is strongly introverted and the remaining options being degrees of introverted/extroverted.)
7. In a group discussion I usually: Options for answers are (only one choice allowed):
   a. Start a conversation;
   b. Join the existing conversation;
   c. Wait until people ask my opinion;
   d. Stay away from people and conversations.
   (With (a) being a person who is strongly extroverted, (d) being a person who is strongly introverted and the remaining options being degrees of introverted/extroverted.)
8. If a phone rings I usually: Options for answers are (only one choice allowed):
   a. Answer the phone without thinking;
   b. Answer if I am the closest to the phone;
   c. Wait for somebody else to answer,
   d. Ask somebody else to answer.
   (With (a) being a person who is strongly extroverted, (d) being a person who is strongly introverted and the remaining options being degrees of introverted/extroverted.)
9. Some people might think that I am: Options for answers are (multiple choices allowed):
   a. Wearing my heart on my sleeve;
   b. Never show my true feelings;
   c. Too open;
   d. Too reserved;
   e. Too loud;
   f. Too quiet;
   g. Talk too much;
   h. Prefer to keep my opinions for myself;
   i. Reckless;
   j. Careful;
   k. Daring;
   1. Cold blooded.
   (a, c, e, g, i, and k indicate an extrovert and b, d, f, h, j and l indicate an extrovert.)
10. I consider myself: (Options for answers are (only one choices allowed):
   a. Definitely extroverted;
   b. more extroverted than introverted;
   c. more introverted than extroverted;
   d. definitely introverted;
   e. I am not sure what introvert/extrovert means.
(With (a) being a person who is strongly extroverted, (e) being a person who is strongly introverted and the remaining options being degrees of introverted/extroverted.)

The answers to each of the questions in this first set of questions will score from −3 (strongly introverted) to +3 (strongly extroverted), with scores in between indicating varying degrees of introversion/extroversion. It is possible to obtain a score of 0 for a neutral choice. For the question 9 each answer scores 1 or −1 on the introversion/extraversion scale depending on whether the answer indicates introverted or extroverted characteristics.

A person would then be characterized by matching service 103 as having introverted or extroverted characteristics base don their total score calculated from their answers to this first question set. For the question set shown above, introverts would be classified as having an aggregate score of 0 or less and extroverts would have an aggregate score of 1 or greater.

If a person were characterized by matching service 103 as having introverted characteristics matching service 103 would communicate to computing device 101 the further set of questions shown below. The answers to this further set of questions are used to determine the extent to which a person is introverted.

Further Set of Questions (Intorvert)

1. How often and how much time do you need to spend alone? Options for answers are (only one choice allowed):
   a. I would prefer to have some time alone every day (−5);
   b. I need to have some time alone a few times a week (−3);
   c. I need to have some time alone at least once a week (−1);
      I need to have some time alone at least once a month or so (0);
   d. I do need some time alone occasionally (+1);
   e. I do need some time alone but it depends on the situation rather than my routine (+3);
   f. I seldom need any time alone (+5);
   g. I never feel the need to be alone (+1 on the scale of dishonesty).
2. At a large party, how many people do you usually exchange your business cards (phones, email addresses) with? Options for answers are (only one choices allowed):
   a. I seldom share my contact information with anybody (−5);
   b. If I like somebody very much, I will probably give them my contact information (−3);
   c. 1-2 people (+1);
   d. 3-5 people (+2);
   e. 6 and more people (+3);
   f. I give my contact information to all people I talk to (+5);
   g. I give my contact information to everybody (+1 on the scale of dishonesty)).
3. How often do you have guests/visitors at your home? Options for answers are (only one choices allowed):
   a. Never (−5);
   b. Occasionally/lrregularly (−4);
   c. Once a year (−3);
   d. A few times a year (−2);
   e. Once a month (−1);
   f. A few times a month (0);
   g. Once a week (+1);
   h. A few times a week (+3);
   i. Nearly every day (+4);
   j. Every day (+5)) (+1 on the scale of dishonesty as the person has been characterized as introverted).
4. How often do you have more than 20 visitors at your home? Options for answers are (only one choices allowed):
   a. Never (−5);
   b. Only if they decide to throw a surprise party for me and come uninvited (−5);
   c. Very seldom (once or twice in a life time) (−4);
   d. Seldom (a few times in a life time) (−3); Once a year or so (−1);
   e. A few times a year (0);
   f. Once a month (+1);
   g. A few times a month (+3);
   h. Once a week (+4);
   i. More than once a week (+5)) (+1 on the scale of dishonesty as the person has been characterized as introverted).
5. Being the center of attention for me means: Options for answers are (only one choices allowed):
   a. Problem (−5);
   b. Embarrassment (−3);
   c. Inconvenience (−1);
   d. Excitement (+1);
   e. Fulfillment (+3);
   f. Ecstasy (+5)) (+1 on the scale of dishonesty as the person has been characterized as introverted).
6. How often do you attend parties with more than 20 people present? Options for answers are (only one choices allowed):
   a. Never;
   b. Seldom (a few times in a life time) (−5);
   c. Once a year or so (−3);
   d. A few times a year (−1);
   e. Once a month or so (0);
   f. A few times a month (+1);
   g. Once a week (+3);
   h. More than once a week (+5) (+1 on the scale of dishonesty as the person has been characterized as introverted).
7. How much communication with new people is involved in your daily work? Options for answers are (only one choices allowed):
   a. I don't meet any new people through my work (−5);
   b. I meet new people through my work occasionally (−3);
   c. I meet new people on a regular basic but not many (−1);
   d. I meet many new people but I don't need to initiate communication with them (+1);
   e. I meet many new people and I need to initiate communication with them (+5) (+1 on the scale of dishonesty as the person has been characterized as introverted);
   f. I don't work (0).
8. How good a listener are you? Options for answers are (only one choices allowed):
   a. I am a very good listener and understand everything from the first time (−5);
   b. I am a good listener and understand most things from the first time (−3);
   c. I am quite a good listener, though sometimes I start thinking what to answer and can miss some things (−1);
   d. I listen until I disagree with something, then I will voice my opinion straight away (+3);
   e. Once I see where the speaker going, I prefer to quickly tell him what is my opinion on the subject (+5) (+1 on the scale of dishonesty as the person has been characterized as introverted).
9. Do you attend yearly meetings with your former classmates? Options for answers are (only one choices allowed):
   a. Never (−5);
   b. I have been there once and did not enjoy it (−3);
   c. I have attended some meetings and missed others (0);
   d. I attend the meetings when I can make it (+3);
   e. I change my schedule to make it to the meetings (5) (+1 on the scale of dishonesty as the person has been characterized as introverted).
10. How high is your energy level? Options for answers are (only one choices allowed):
   a. I have a very high energy level [I am the one who charges others] (+5) (+1 on the scale of dishonesty as the person has been characterized as introverted);
   b. I have above average energy level [I am still fresh when others feel tired] (+3);
   c. I have an average energy level [I get tired the same as others] (−1);
   d. I have below average energy level [I am usually one of the first people to quit] (−5).

The extent to which a person is introverted would then be determined by matching service 103 based on their aggregate score from the questions above. The more negative this score is, the more introverted they are. This information is then used by matching service 103 to develop the person's character profile.

Additionally, the answers are used when calculating an honesty and consistency scale to determine the level of honesty a person is displaying when answering the questions. For example, if a person answered questions 1 and 2 below with (g) then they would receive a positive rating on the dishonesty scale as they are indicating that they are extroverted when they have been characterized as being introverted in the previous question set.

If a person were characterized by matching service 103 as having extroverted characteristics as a result of the answers they provided to the first set of questions then they would receive the following set of questions to provide further information about the extent of their extroversion.

Further Set of Questions (Extrovert)

1. How often do you spend time with people outside the circle of your colleagues and people you share your home with? Options for answers are (only one choices allowed):
   I. Every day (+5);
   II. A few times a week (+3);
   III. Every week(+1);
   IV. A few times a month (0);
   V. Once a month (−1);
   VI. A few times a year (−3);
   VII. Occasionally/lrregularly (−5) (+1 on the scale of dishonesty as the person has been characterized as extroverted).
2. At a large party, how many people do you usually exchange your business cards (phone numbers, email addresses) with? Options for answers are (only one choices allowed):
   I. I give my contact information to everybody;
   II. I give my contact information to all people I talk to (+5);
   III. 6 and more people (+3);
   IV. 3-5 people (+2);
   V. 1-2 people (+1);
   VI. If I like somebody very much, I will probably give them my contact information (−3);
   VII. I seldom share my contact information with anybody (−5) (+1 on the scale of dishonesty as the person has been characterized as extroverted).
3. How often do you have guests/visitors at your home? Options for answers are (only one choices allowed):
   I. Every day (+5);
   II. Nearly every day (+4);
   III. A few times a week (+3);
   IV. Once a week (+1);
   V. A few times a month (0);
   VI. Once a month (−1);
   VII. A few times a year (−2);
   VIII. Once a year (−3);
   IX. Occasionally/lrregularly (−4);
   X. Never (−5) (+1 on the scale of dishonesty as the person has been characterized as extroverted).
4. How often do you have more than 20 visitors at your home? Options for answers are (only one choices allowed):
   I. More than once a week (+5);
   II. Once a week (+3);
   III. A few times a month (+1);
   IV. Once a month (−1);
   V. A few times a year (0);
   VI. Once a year or so (−3);
   VII. Seldom (a few times in a life time) (−4);
   VIII. Never (−5) (+1 on the scale of dishonesty as the person has been characterized as extroverted).
5. Being the center of attention for me means: Options for answers are (only one choices allowed):
   I. Ecstasy (+5);
   II. Excitement (+1);
   III. Fulfillment (+3);
   IV. Inconvenience (−1);
   V. Embarrassment (−3);
   VI. Problem (−5) (+1 on the scale of dishonesty as the person has been characterized as extroverted).
6. How often do you attend parties with more than 20 people present? Options for answers are (only one choices allowed):
   1. More than once a week (+5);
   II. Once a week (+3);
   III. A few times a month (+1);
   IV. Once a month or so (0);
   V. A few times a year (−1);
   VI. Once a year or so (−3);
   VII. Seldom (a few times in a life time) (−5);
   VIII. Never (+1 on the scale of dishonesty))
7. How much communication with new people is involved in your daily work? Options for answers are (only one choices allowed):
   I. I meet many new people and I need to initiate communication with them (+5);
   II. I meet many new people but I don't need to initiate communication with them (+1);
   III. I meet new people on a regular basic but not many (+0);
   IV. I meet new people through my work occasionally (−3);
   V. I don't meet any new people through my work (−5) (+1 on the scale of dishonesty as the person has been characterized as extroverted).
8. How good a speaker are you? Options for answers are (only one choices allowed):
   I. I am a very good speaker and enjoy speaking to large groups of people (+5);
   II. I am a good speaker and speaking to large groups of people does not frighten me (+3);
   III. I am quite a good speaker, though I am not very comfortable speaking to large groups of people (0);
   IV. I am not very good in speaking to large groups of people, but if it's really necessary, I can do it (−3);
   V. I am frightened of speaking to large groups of people (−5) (+1 on the scale of dishonesty as the person has been characterized as extroverted).
9. How many of your former school/university classmates do you still keep in contact with? Options for answers are (only one choices allowed):
   I. more than 20 people (+5);
   II. 11-20 people (+3);
   III. 6-10 people (+1);
   IV. 3-5 people (0);
   V. 1-2 people (−3);
   VI. None (−5) (+1 on the scale of dishonesty as the person has been characterized as extroverted).
10. How high is your energy level? Options for answers are (only one choices allowed):
   I. I have a very high energy level [I am the one who charges others] (+5);
   II. I have above average energy level [I am still fresh when others feel tired] (+3);
   III. I have an average energy level [I get tired the same as others] (−1);
   IV. I have below average energy level [I am usually one of the first people to quit] (−5)) (+1 on the scale of dishonesty as the person has been characterized as extroverted).

The extent to which a person is extroverted would then be calculated by matching service 103 based on their aggregate score from the questions above. The more positive this score is, the more extroverted they are. This information is then used by matching service 103 to develop the person's character profile.

The example given above provides one possible method in which matching service 103 provides a person with a series of questions wherein the content of further sets of questions communicated from matching service 103 to computing device 101 are determined by the answers a person gives to the previous set of questions.

Furthermore, the above example provides one method by which the matching service 103 of the present invention develops a character profile of a person. Alternatively, matching service 103 employs complex algorithms for providing additional sets of questions. For example, based on the answers provided by a person to a first set of question, application software module 105 implements rule based algorithms, based on psychological rules, to compile a set of questions. Preferably, these questions are retrieved from storage module 106 that contains a very large index of questions.

Preferably, the total number of questions given to a person over the course of the questionnaire will be greater than 200 and more preferably greater than 500 questions will be provided. As previously discussed, dispersed throughout these questions will be questions that are used to determine the consistency and honesty with which a person is answering the questions. Preferably, there will be a plurality of questions (e.g. 2 to 4) dispersed throughout the questions that are used to determine the consistency with which a person is answering the questions.

The questions used to test how consistently a person is answering the question sets may be in the form of three questions that ask exactly the same question. For example, dispersed throughout all the questions the following question numbers may take the form:
23) Do you like camping?
120) Do you like camping?
215) Do you like camping?

The answers given by a person to these questions should be the same if they are answering all questions in a consistent manner. As these questions are separated sufficiently in the chronological order of questions and/or may be in different questions sets such that a person answering may not remember that this question has been asked to them before.

Alternatively, how consistently and honestly a person is answering the questions may be tested by asking questions that should receive opposite answers. For example, dispersed throughout all the questions the following question numbers may take the form:
45) Do you enjoy flying?
190) Do you have a fear of flying?

The answers given by a person for these two questions should be different. Hence, if a person answers “yes” to question 45 then they should answer “no” to question 190 and vice versa if they are answering the questions consistently and honestly.

The questions that are used to determine how consistently and honestly a person is answering the question sets may also take the form of asking a person a precise question and then asking them a more general question that should receive the same answer as the first question. A good example of this type of question relates to geographical type questions as indicated below.
12) Have you ever been to Sydney?
205) Have you ever been to Australia?

If a person answers in the affirmative to the first question then they should also answer in the affirmative to the second question if they are answering the questions consistently.

Preferably, the consistency and honesty questions are combined into a scale and are used by matching service 103 to determine compatibility between people during the matching process as will be discussed in more detail below.

After sufficient number of question sets have been provided to the person, the matching service 103 compiles a hidden character profile of that person (step 206). This character profile contains information concerning the character of a person, their interests, their aspirations, the qualities desired in a potential mate, among other details.

Hence, the character profile of a person includes a numerical rating of a plurality of character traits of a person. These character traits include introverted/extroverted, happy/sad, motivated/lazy, angry/placid, happy/sad and other such character traits as will be readily identified by a person skilled in the art. It will be appreciated that whilst the example given above show how a numerical rating for a person's introversion/extroversion is shown, a similar process can be used to provide for a numerical rating of all character traits of a person.

Preferably, the matching service 103 determines that a sufficient number of question sets have been provided to the person when a threshold number of questions have been asked and answers given. Optionally, the matching service 103 may continually provide question sets until a number of characteristics of a person have been accurately ascertained. For example, in the introverted/extroverted example above the matching service 103 will continually provide question sets to the person until the person has reached a threshold number of questions for that character trait. Similarly, a plurality of character traits are analyzed in this way until the person has answered a sufficient number of questions for each character trait.

Optionally, matching service 103 also creates a public profile that contains information about a person similar in content to those created by prior art dating services. Hence, matching service 103 creates two profiles for each person. One is not published and remains secret and contains information regarding the persons character profile developed by matching service 103. The second is publicly accessible and contains information about the persons interests, hobbies and other similar details and is available for other users of matching service 103 to view.

The matching service 103 then stores the persons character profile in storage module 106 of matching service 103 (step 207) and also stores and makes accessible the persons public profile. This information is stored in such a way so that it may be logically searched when the matching service 103 is undertaking a compatibility match search for a person.

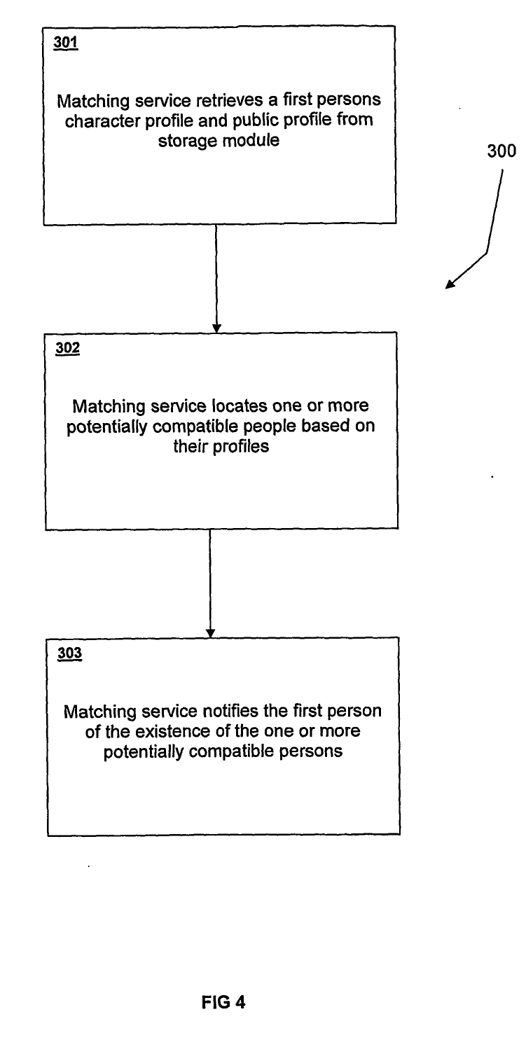

FIG. 4 shows the step of matching people (step 300 in FIG. 2) in more detail. Preferably, in the method of matching people of the present invention, a person never sees the character profile developed for them by the matching service 103. Furthermore, other users of matching service 103 cannot ever see a persons character profile. Hence, a person does not know how the matching service has characterized them and all compatibility matching is undertaken by matching service 103 (step 300 in FIG. 2). However, the public profile containing information regarding a persons interests, hobbies, etc is published on the Internet site administered by matching service 103.

The application software module 105 retrieves the character profile and the public profile of a person from the storage module 106 in order that a compatibility match can be carried out for this person (step 301). The application software module 105 then iterates over all the profiles in the storage module 106 in order to find compatible people for this person based on the personality profiles (step 302).

This involves comparing the character profile of a person with the character profile of persons stored in storage module 106 and determining whether they would be compatible based on a set of criteria. Other criteria that are then used are the more material criteria such as interests, hobbies, and ambitions as described in a persons public profile.

People who have similar character profiles and interests are more compatible than people who have diverging characters and interests. For example, an introverted person who enjoys reading and watching movies will not be compatible with a extrovert who enjoys rock climbing and going to nightclubs.

For example, a person who has a high introversion rating would be preliminarily matched with another person who has a high introversion rating.

Additionally, matching service 103 takes into account the responses people have given to the same question with the goal of matching people who have provided exactly the same answers to exactly the same questions. This provides a good basis for compatibility for matching people with each other by matching service 103. These people should be highly compatible as their similar answers show that they react to the world in exactly the same way.

People with similar character profiles will be more compatible with people whose answers exactly match their answers (for example, they both have said they have guests at home a few times a week) than with people who have the same personality type (i.e scoring the same on the introversion/extroversion scale for example) but have answered the questions in a different manner (i.e one person has said they have guests at their home a few times a week and the other person has said that they only occasionally have guests at their home). If there is an exact match with peoples answers then the people are more compatible and matching service 103 takes this into account when matching by increasing the level of compatibility of the two people.

Finally, the level of honesty demonstrated by the person and how consistently the questions were answered are analyzed. For example, consider the case where two people are totally compatible in terms of character and interests but one person has answered all the questions consistently and honestly and the matching service 103 has determined that the other person has not been honest or consistent when answering the sets of questions. These two people, upon meeting may find that they are incompatible as one of the people has lied about themselves in the questionnaire.

Obviously, two people who are compatible based on interests and characters and both rate highly on the honesty and consistency scale will be far more compatible than two people who appear to be compatible based on interests and characters but rate lower on the honesty and consistency scale. This is due to the fact that there is less certainty in the answers provided by the dishonest people and hence the matching service can only attempt to match based on uncertain data.

Preferably, if a person has answered all the questions in a consistent and honest manner they will not be matched with someone who has lied about their character and interests in an attempt to be matched with a more desirable mate.

Additionally, two people who have similar interests, personality types, have answered the questions in a honest and consistent manner and have answered a high proportion of questions with exactly the same responses will be highly compatible.

Hence, matching service 103 compiles a numerical rating of how compatible a person is with other persons based on the character profile which includes such information as character trait ratings, whether similar questions were answered in a similar manner, whether each person has common interests and the level of honesty and consistency each person displayed when answering the questions provided amongst other criteria.

Preferably, people who have compatible character profiles will have a significant number of similar numerical ratings for the same character traits that form part of their character profile. Optionally, these numerical ratings may be within a predetermined threshold (i.e within %5).

A person may instruct matching service 103 to conduct a compatibility match at any time after they have completed the sets of questions. When a potential match has been found for that person they are then able to view the published profiles of the individuals identified by matching service 103 as being compatible. If the person decides to initiate contact with these people then they allow matching service 103 to notify one or more of these potentially compatible people of their desire to establish contact.

Optionally, a person can instruct the matching service 103 to conduct routine (i.e weekly, monthly, etc) compatibility matches for a person and notify that person when potentially compatible people have been identified for them by matching service 103.

The improved method of matching people of the present invention provides significant advantages over methods known in the art. It is not possible for a person to misrepresent their character or lie when filling in the one or more sets of questions without these lies and misrepresentations being detected by matching service 103. This means that, for people who complete the questionnaire honestly, there will be a higher chance of being matched with a truly compatible person.

Furthermore, by offering sets of questions that are configured dynamically based on a persons answers to the previous set of questions a more detailed and accurate profile of a persons character can be developed by the matching service. This is a significant advantage over methods known in the art wherein a person is asked a set of generic questions that aren't configured dynamically to profiles elements of their character.

Throughout the specification the aim has been to describe the invention without limiting the invention to any one embodiment or specific collection of features. Persons skilled in the relevant art may realize variations from the specific embodiments that will nonetheless fall within the scope of the invention.

Although the method of the present invention as seen described in relation to matching people in an Internet dating situation, the method may be applied to other applications such as matching a person to a job wherein the compatibility of a persons character profile is matched to a desired character profile as specified by an employer. Other possible applications involve vocational guidance and public relations.

1. A method in a computer system of matching people, said method including the steps of:
a. providing a first set of questions to a first person;
b. analyzing a set of answers provided by said first person to said first set of questions;
c. one or more iterations of:
i. providing a further set of questions to said first person, wherein the content of said further set of questions being determined by a set of answers provided by said first person to at least one previous set of questions; and
ii. analyzing said set of answers provided by said first person to said further set of questions;
d. developing a character profile of said first person based on said analyses of said answers to said first set of questions in step (b) and said analyses of said answers to said further set(s) of questions in step (c(ii)); and
e. determining a compatibility of said first person with at least one other person based on said character profile of said first person and a character profile of each said other person.

2. The method of matching people according to claim 1, wherein each said further set of questions includes questions to determine the consistency with which said first person is answering said questions.

3. The method of matching people according to claim 1, wherein said method further includes the step of storing said character profile of said first person developed in step (d).

4. The method of matching people according to claim 1, wherein each said other persons have a character profile stored in said computer system.

5. The method of matching people according to claim 1, wherein said method further includes the step of making accessible a public profile of said first person.

6. The method of matching people according to claim 1, wherein said character profile developed in step (d) is not accessible by said first person or any of said other persons.

7. The method of matching people according to claim 1, wherein said method further includes the step of notifying said first person of each said other person if said first person is compatible with said other person.

8. The method of matching people according to claim 1, wherein step (d) is undertaken at predetermined time intervals.

9. The method of matching people according to claim 1, wherein step (d) is undertaken upon receipt of a request from said first person.

10. The method of matching people according to claim 1, wherein said character profile includes a numerical rating of one or more of a persons character traits.

11. The method of matching people according to claim 10, wherein said character traits are selected from a set of character traits which include: introverted/extroverted, happy/sad, motivated/lazy, angry/placid.

12. The method of matching people according to claim 1, wherein said character profile includes an indication of how consistently a person has answered said first set of questions and each of said one ore more further sets of questions.

13. The method of matching a person according to claim 1, wherein step (e) involves comparing a numerical index of a plurality of character traits of said first person with each said other person.

14. The method of matching a person according to claim 1, wherein step (e) involves comparing a numerical index of one or more character traits of said first person with each said other person and determining whether said numerical index of said first person within a tolerance with said numerical index of each said other persons.

15. The method of matching a person according to claim 1, wherein step (e) involves comparing said first persons answer to an identical question that said one or more second persons have also answered.

16. The method of matching a person according to claim 1, wherein step (e) involves comparing a first persons interests to interests of said one or more other persons.
